(19) United States
(12) Patent Application Publication
(10) Pub. No.: US 2023/0330792 A1
(43) Pub. Date: Oct. 19, 2023

(54) SPRING COMPRESSOR

(71) Applicant: Fox Factory, Inc., Duluth, GA (US)

(72) Inventors: Alex Toro, Gainesville, GA (US); Chris Rohde, Lula, GA (US)

(73) Assignee: Fox Factory, Inc., Duluth, GA (US)

(21) Appl. No.: 17/987,301

(22) Filed: Nov. 15, 2022

Related U.S. Application Data
(60) Provisional application No. 63/281,013, filed on Nov. 18, 2021.

(51) Int. Cl. B23P 19/04

(52) U.S. Cl. CPC B23P 19/048; F16F 2226/04; B60G 2206/921

(57) ABSTRACT

A spring compressor is disclosed. The spring compressor includes a frame, a lower shock assembly mount, a top hat mount, and a compressing component. The compressing component coupled with the frame, the lower shock assembly mount, and the top hat mount, the compressing component to provide a compression on a spring by reducing a distance between the lower shock assembly mount and the top hat mount.

### CROSS-REFERENCE TO RELATED APPLICATIONS (PROVISIONAL)

This application claims priority to and benefit of co-pending U.S. Provisional Patent Application No. 63/281,013 filed on Nov. 18, 2021, entitled “SPRING COMPRESSOR” by Alex Toro et al., and assigned to the assignee of the present application, the disclosure of which is hereby incorporated by reference in its entirety.

### FIELD OF THE INVENTION

Embodiments of the invention generally relate to a spring compressor.

### BACKGROUND

Shock assemblies are used in numerous different vehicles and configurations to absorb some or all of a movement that is received at a first portion of a vehicle before it is transmitted to a second portion of the vehicle. For example, when a front tire of a vehicle hits a rough spot, the encounter will cause an impact force. However, by utilizing suspension components including one or more shock assemblies, the impact force can be significantly reduced or even absorbed completely before it is transmitted to a vehicle operator.

Some shock assemblies, such as a coil over shock assembly, includes an exterior spring, with a large spring constant, to maintain the shock assembly in an expanded (or less compressed) state and provide the expansive force used for rebound of the shock assembly. However, when aspects of a shock assembly with a spring need to be modified, e.g., for performance changes (such as a heavier spring, lighter spring, etc.), spring replacement, spring removal for rebuild/replacement of other components of the shock assembly, and the like, the spring needs to be compressed to remove the expansive force from the shock assembly to allow disassembly thereof. Often, providing appropriate compressive force to the spring can result in deleterious situations where the spring is precariously compressed and can, and have been known to, have accidental releases therefrom resulting in dangerous and deadly spring expansion. Thus, what is needed in the art are improved techniques for compressing the spring of the shock assemblies.

### BRIEF DESCRIPTION OF THE DRAWINGS

Aspects of the present invention are illustrated by way of example, and not by way of limitation, in the accompanying drawings, wherein:

FIG. 1 is a perspective view of a coil sprung shock assembly, in accordance with one embodiment.

FIG. 2 is a perspective view of a spring compressor, in accordance with an embodiment.

FIG. 3 is a perspective view of the spring compressor of FIG. 2 with the coil sprung shock assembly of FIG. 1 installed therein, in accordance with an embodiment.

FIG. 4A is a detail view of a section of FIG. 3, in accordance with an embodiment.

FIG. 4B is a detail view of another section of FIG. 3, in accordance with an embodiment.

The drawings referred to in this description should be understood as not being drawn to scale except if specifically noted.

### DESCRIPTION OF EMBODIMENTS

The detailed description set forth below in connection with the appended drawings is intended as a description of various embodiments of the present invention and is not intended to represent the only embodiments in which the present invention is to be practiced. Each embodiment described in this disclosure is provided merely as an example or illustration of the present invention, and should not necessarily be construed as preferred or advantageous over other embodiments. In some instances, well known methods, procedures, and objects have not been described in detail as not to unnecessarily obscure aspects of the present disclosure.

### Terminology

In the following discussion, a number of terms and directional language is utilized. Although the technology described herein is useful on a number of different suspension systems that use a shock assembly, a wheeled vehicle is used in the following description for purposes of clarity.

In general, a suspension system for a vehicle provides a motion modifiable connection between a portion of the vehicle that is in contact with a surface (e.g., an unsprung portion) and some or all of the rest of the vehicle that is not in contact with the surface (e.g., a suspended portion). For example, the unsprung portion of the vehicle that is in contact with the surface can include one or more wheel(s), skis, tracks, hulls, etc., while some or all of the rest of the vehicle that is not in contact with the surface include suspended portions such as a frame, a seat, handlebars, engines, cranks, etc.

The suspension system will include one or numerous components which are used to couple the unsprung portion of the vehicle (e.g., wheels, skids, wings, belt, etc.) with the suspended portion of the vehicle (e.g., seat, cockpit, passenger area, cargo area, etc.). Often, the suspension system will include one or more shock assemblies which are used to reduce feedback from the unsprung portion of the vehicle before that feedback is transferred to the suspended portion of the vehicle, as the vehicle traverses an environment. However, the language used by those of ordinary skill in the art to identify a shock assembly used by the suspension system can differ while referring to the same (or similar) types of components. For example, some of those of ordinary skill in the art will refer to the shock assembly as a shock absorber, while others of ordinary skill in the art will refer to the shock assembly as a damper (or damper assembly).

In its basic form, the suspension is used to increase ride comfort, performance, endurance, component longevity and the like. In general, the force of jarring events, rattles, vibrations, jostles, and the like which are encountered by the portion of the vehicle that is in contact with the surface are reduced or even removed as it transitions through the suspension before reaching suspended portions of the vehicle to include components such as seats, steering wheels/handlebars, pedals/foot pegs, fasteners, drive trains, engines, and the like.

For example, on a wheeled vehicle, a portion of the wheel (or tire) will be in contact with the surface being traversed (e.g., pavement, dirt, gravel, sand, mud, rocks, etc.) while a shock assembly and/or other suspension system components will be coupled between a wheel retaining assembly and the suspended portion of the vehicle (often a portion of the vehicle frame and associated systems, the seat, handlebars, pedals, controls, steering wheel, interior, etc.).

In a snow machine, a portion of the track and/or the skis that will be in contact with the surface being traversed (e.g., snow, ice, etc.) while a shock assembly and/or other suspension components will be coupled between a track retaining assembly (and similarly the skis retaining assembly) and the suspended portion of the vehicle (usually including the engine and associated systems, the seat, handlebars, etc.).

In a boat or PWC vehicle, a portion of the hull will be in contact with the surface of the water while a shock assembly and/or other suspension components will be coupled between the hull and the suspended portion(s) of the vehicle (such as the seat, the handlebars, a portion of the vehicle frame, and/or the like).

The term initial sag settings or “sag” refers to a pre-defined vehicle ride height and suspension geometry based on the initial compression of one or more shock assemblies of the suspension system for a given vehicle when it is within its normal load envelope configuration (e.g., with a rider/driver/user and any initial load weight). Once the sag is established for a vehicle, it will be the designated ride height of the vehicle, until and unless the sag is changed.

The initial sag for a vehicle is usually established by the manufacturer. The vehicle sag can then be modified and/or adjusted by an owner, a mechanic, or the like. For example, an owner can modify the sag to designate a new normal ride height based on a vehicle use purpose, load requirements that are different than the factory load configuration, an adjustment modification and/or replacement of one or more of the suspension components, a change in tire size, a performance adjustment, aesthetics, and the like.

In one embodiment, the initial manufacturer will use sag settings resulting in a pre-established vehicle ride height based on vehicle use, size, passenger capacity, load capacity, and the like. For example, a truck (side-by-side, car, bicycle, motorcycle, snowmobile, or the like) may have a pre-established sag based on an expected load (e.g., a number of passengers, an expected cargo requirement, etc.).

Regardless of the vehicle type, once the sag is established, in a static situation the ride height of the expectedly loaded vehicle should be at or about the established sag. When in motion, the ride height will change as the vehicle travels over the surface, and while the suspension system is used to reduce the transference of any input forces received from the surface to the rest of the vehicle it is also used to maintain the vehicle's sag. Additional information regarding sag and sag setup can be found in U.S. Pat. No. 8,838,335 which is incorporated by reference herein, in its entirety.

As vehicle utilization scenarios change, shock assembly components may be adjusted, replaced, modified, or the like for different characteristics based on the use type of the vehicle, terrain, purpose (e.g., rock crawl, normal use, race set-up, hill climb, etc.), and the like. For example, a downhill mountain bike rider (motocross rider, off-road truck driver, side-by-side rider, snow machine racer, etc.) would want a suspension configuration with a large range of motion and aggressive rebound and compression speeds to maintain as much contact as possible between the tires and the ground by absorbing the terrain events such as bumps, ruts, roots, rocks, dips, etc. while reducing the impacts felt at the suspended portion and also have the suspension return to its personal sag setting as quickly as possible in preparation for the next encounter.

In contrast, a flat (or smooth terrain) vehicle user would want a firmer suspension configuration with a very small range of motion to provide feel for the grip of the tire, maintain friction and/or aerodynamic geometries, and the like, in order to obtain the maximum performance from the vehicle.

### Operation

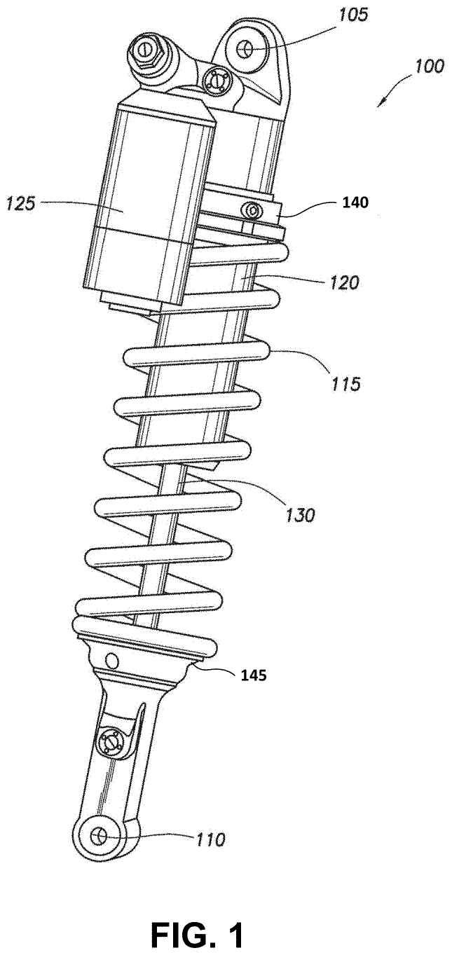

With reference now to FIG. 1, a perspective view of a coilover or coil sprung shock assembly 100 is shown in accordance with one embodiment. In one embodiment, coil sprung shock assembly 100 includes eyelets 105 and 110, damper housing 120, helical spring 115, piston shaft 130, top hat 140, spring seat 145, and an optional piggyback (or external) reservoir 125. A configuration of an external reservoir, including a floating piston, is described in U.S. Pat. No. 7,374,028 the content of which is incorporated by reference herein, in its entirety.

In one embodiment, helical spring 115 is held in compression between spring seat 145 and top hat 140.

In one embodiment, the damper housing 120 includes a piston and chamber and the external reservoir 125 includes a floating piston and pressurized gas to compensate for a reduction in volume in the main damper chamber of the coil sprung shock assembly 100 as the piston shaft 130 moves into the damper housing 120. Fluid communication between the main chamber of the damper housing 120 and the external reservoir 125 may be via a flow channel including an adjustable needle valve. In its basic form, the damper housing 120 works in conjunction with the helical spring 115 and controls the speed of movement of the piston shaft by metering incompressible fluid from one side of the damper piston to the other, and optionally from the main chamber to the reservoir 125, during a compression stroke (and in reverse during the rebound or extension stroke).

Although a coil sprung shock assembly 100 with a single helical spring 115 is shown in FIG. 1, this is provided as one embodiment and for purposes of clarity. In one embodiment, there could be a plurality of helical springs 115 used by the coil sprung shock assembly 100.

In general, the coil sprung shock assembly 100 may be used on vehicles such as, but not limited to a bicycle, an electric bike (e-bike), a hybrid bike, a scooter, a motorcycle, an ATV, a personal water craft (PWC), a vehicle with three or more wheels (e.g., a UTV such as a side-by-side, a car, truck, etc.), an aircraft, and the like. In one embodiment, the coil sprung shock assembly 100 is also suited for use in suspension inclusive devices such as, but not limited to, an exoskeleton, a seat frame, a prosthetic, a suspended floor, and the like.

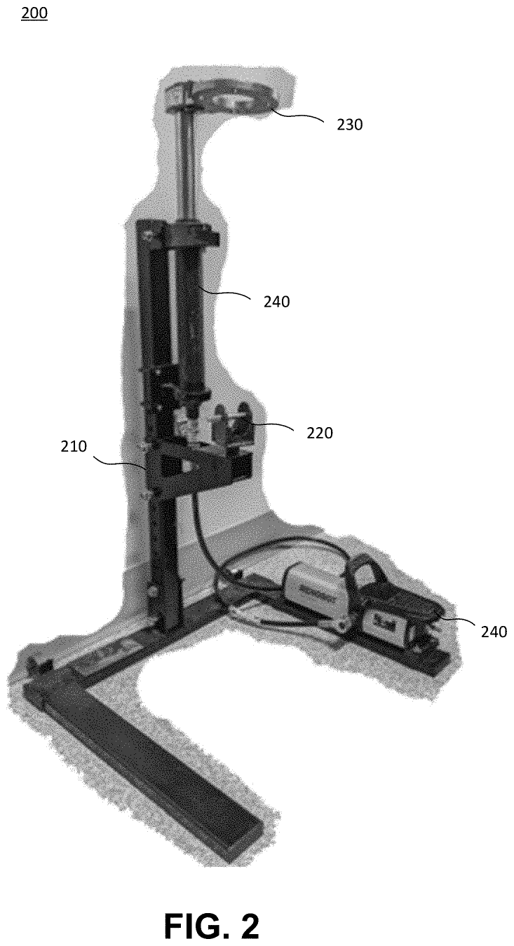

With reference now to FIG. 2, a perspective view of a spring compressor 200 is shown in accordance with an embodiment. In one embodiment, spring compressor 200 includes frame 210, lower shock assembly mount 220, top hat mount 230, compressing component 240, and a compressing component controller 250.

In one embodiment, lower shock assembly mount 220 and compressing component 240 are coupled with the frame 210 while top hat mount 230 is coupled with compressing component 240. Although shown in this configuration in FIG. 2, it should be appreciated that in other embodiment, the components of FIG. 2 may be coupled with one another in different configurations such as discussed herein.

For example, in one embodiment, top hat mount 230 and compressing component 240 are coupled with the frame 210 while lower shock assembly mount 220 is coupled with compressing component 240.

In one embodiment, only compressing component 240 is coupled with the frame 210 and the lower shock assembly mount 220 and top hat mount 230 are coupled with compressing component 240.

In one embodiment, only lower shock assembly mount 220 is coupled with the frame 210 and the compressing component 240 and top hat mount 230 are coupled with lower shock assembly mount 220.

In one embodiment, only top hat mount 230 is coupled with the frame 210 and the compressing component 240 and lower shock assembly mount 220 are coupled with a portion of the top hat mount 230.

In one embodiment, frame 210 is a stand. In one embodiment, frame 210 is a mobile stand. In one embodiment, frame 210 is a fixedly located stand (e.g., capable of being bolted to a floor or otherwise relatively immobile). In one embodiment, frame 210 is a wall-mount frame or the like.

Moreover, in one embodiment, it should be appreciated that the orientation of the components of FIG. 2 may be horizontal, or at some type of angle instead of vertically oriented as shown in FIG. 2.

In one embodiment, spring compressor 200 is an air over hydraulic type spring compressor. In one embodiment, compressing component 240 could be completely pneumatic, hydraulic, mechanical (i.e. hand-crank), or any combination thereof (e.g. manual pumped hydraulic, etc.).

In one embodiment, spring compressor 200 includes an interchangeable top hat mount 230.

In one embodiment, spring compressing component controller 250 is a foot control. In one embodiment, spring compressing component controller 250 may be located in a different location, or controlled by a hand control, switch, button, or the like.

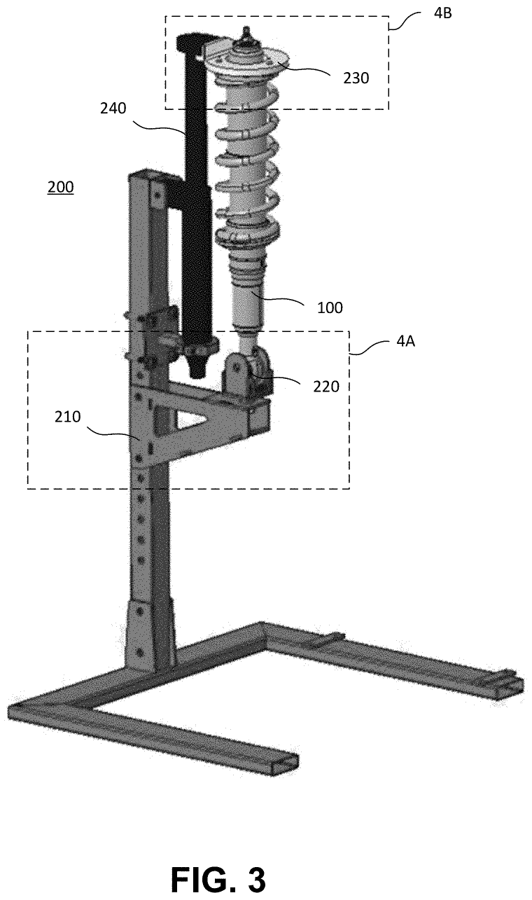

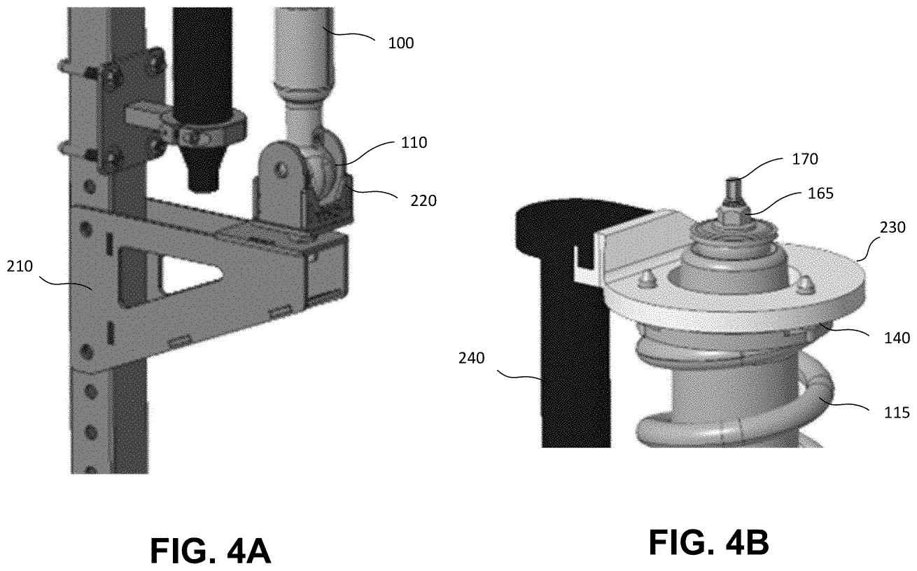

In one embodiment, the compressing component 240 moves the top hat mount 230 toward or away from lower shock assembly mount 220 to provide (e.g., moves toward) or remove (e.g., moves away) a compression force on a spring of a shock assembly mounted therein. In one embodiment, the compressing component 240 moves lower shock assembly mount 220 toward or away from the top hat mount 230 to provide (e.g., moves toward) or remove (e.g., moves away) a compression force on a spring of a shock assembly mounted therein. In one embodiment, the compressing component 240 moves one or both of the top hat mount 230 and lower shock assembly mount 220 toward or away from the other of the top hat mount 230 and the lower shock assembly mount 220 to provide (e.g., moves toward) or remove (e.g., moves away) a compression force on a spring of a shock assembly mounted therein. Further description of the movement and operation of spring compressor 200 is provided in the discussion of FIGS. 3, 4A, and 4B.

Referring now to FIG. 3, a perspective view of the spring compressor 200 of FIG. 2 with the coil sprung shock assembly 100 of FIG. 1 installed therein is shown in accordance with an embodiment.

In one embodiment, coil sprung shock assembly 100 is mounted on spring compressor 200 between lower shock assembly mount 220 and top hat mount 230. In one embodiment, as spring compressor 200 is activated to compress the helical spring 115 of coil sprung shock assembly 100, compressing component 240 will cause top hat mount 230 to move down toward lower shock assembly mount 220.

In contrast, when spring compressor 200 is activated to reduce any compression on the helical spring 115 of coil sprung shock assembly 100, compressing component 240 will cause top hat mount 230 to move upward away from lower shock assembly mount 220.

As discussed herein, existing spring compression tools do not completely retain the helical spring 115 creating a potentially unsafe condition for the operator, a bystander, the shock assembly and/or its components, and the like. For example, an existing spring compression tool only applies a force to the spring. As such, when the top hat is installed, it is often difficult to align the spring seat 145 and top hat 140 with the helical spring 115 because the spring tension must be carefully released while the top hat 140 is simultaneously guiding into the correct orientation. In contrast, embodiments of the spring compressor 200 tool compress the helical spring 115 using the top hat 140, so it is aligned before the helical spring 115 is ever compressed.

In other words, embodiments described herein provide new and novel spring compressor 200 for helical spring 115 installation that provides a previously unavailable level of safety during the compression of helical spring 115. Moreover, embodiments disclosed herein provide a previously unavailable level of repeatability as the helical spring 115 is retained beneath the top hat 140 as it is compressed. In addition, the components of coil sprung shock assembly 100 (within the helical spring 115) are also held in position by the spring compressor 200 such that the helical spring 115 has no way to escape during a compression thereof.

In one embodiment, the top hat mount 230 is a compression adapter that makes no contact with the helical spring 115, preventing damage to the helical spring 115 during compression thereof. That is, the top hat mount 230 will provide contact with top hat 140, while top hat 140 will be in contact with helical spring 115.

With reference now to FIG. 4A, a detail view of a section of FIG. 3 is shown in accordance with an embodiment. In one embodiment, FIG. 4A shows a detailed view of the lower shock assembly mount 220 engaging the eyelet 110 of coil sprung shock assembly 100. In one embodiment, lower shock assembly mount 220 is modular for different length shock assemblies. In one embodiment, lower shock assembly mount 220 is modular for different lower mount configurations such as, but not limited to, an eyelet mount, a clevis mount, a slip-mount, a knuckle-mount, or the like).

Referring now to FIG. 4B is a detail view of another section of FIG. 3 is shown in accordance with an embodiment.

In one embodiment, top hat mount 230 is selected from a plurality of different top hat mounts 230 to be able to work with different shock assemblies/top hat types/styles. In one embodiment, top hat mount 230 includes mounting holes, or slotted mounting holes to allow for multiple bolt-patterns for a given central bore (or smaller).

In basic operation, the coil sprung shock assembly 100 is mounted within the spring compressor 200 such that eyelet 110 is coupled with lower shock assembly mount 220. The top hat mount 230 is then located above the top hat 140 and aligned with the bolts of top hat 140 and central bore 170. When the compressing component 240 begins a compression stroke, the top hat mount 230 pushes top hat 140 downward to compress helical spring 115 between the top hat 140 and the lower spring seat 145. Once an amount of compression has been applied, the bolt 165 is then tightened or loosened depending upon the task being performed.

For example, if helical spring 115 is initially being installed on coil sprung shock assembly 100, compressing component 240 will compress the top hat 140 via top hat mount 230 while lower shock assembly mount 220 will maintain the position of the body of coil sprung shock assembly 100. In so doing, helical spring 115 will be compressed with respect to the body of coil sprung shock assembly 100. Once helical spring 115 is compressed the appropriate amount, nut 165 will be tightened and the coil sprung shock assembly 100 will be assembled. At that time, compressing component 240 will begin to move the top hat mount 230 away from lower shock assembly mount 220 to release the compression force being applied to top hat 140. Once the compression force is no longer being applied by compressing component 240, the coil sprung shock assembly 100 can be removed from spring compressor 200.

In contrast, if helical spring 115 is being uninstalled from coil sprung shock assembly 100 (or the spring tension released to allow modification, change, or the like to one or more components of coil sprung shock assembly 100), compressing component 240 will compress the top hat 140 via top hat mount 230 while lower shock assembly mount 220 will maintain the position of the body of coil sprung shock assembly 100. In so doing, helical spring 115 will be compressed with respect to the body of coil sprung shock assembly 100 such that the spring pressure is released with respect to nut 165, nut 165 will be removed. Once the nut 165 is removed, compressing component 240 will begin to allow the top hat mount 230 to slowly move away from lower shock assembly mount 220 to release the compression force on helical spring 115. Once helical spring 115 is no longer under any compression force, some, part, or all of the coil sprung shock assembly 100 can be removed from spring compressor 200.

For example, if the helical spring 115 is being changed, once the original helical spring is no longer under any compressive load, it can be lifted from the body of coil sprung shock assembly 100. The new helical spring 115 would then by placed over the body of coil sprung shock assembly 100 and set in position on spring seat 145. Then, as described above, the spring compressor 200 would once again apply compression to the new helical spring 115 (in the same manner as described above e.g., via top hat mount 230 acting on top hat 140) until top hat 140 is in its proper location and nut 165 is able to be tightened. At that time, the compression force from compressing component 240 would be removed and the coil sprung shock assembly 100 with a new helical spring 115 could be safely removed from spring compressor 200.

In one embodiment, instead of the compressing component 240 moving the top hat mount 230 toward lower shock assembly mount 220 to provide the compression, lower shock assembly mount 220 will be movable such that compressing component 240 will move lower shock assembly mount 220 toward top hat mount 230 to provide the compression (and similarly move lower shock assembly mount 220 away from the top hat mount 230 to remove the compression).

In one embodiment, compressing component 240 will move one or both of the top hat mount 230 toward lower shock assembly mount 220 and the lower shock assembly mount 220 toward top hat mount 230 to provide the compression (and similarly move one or both of the top hat mount 230 away from lower shock assembly mount 220 and the lower shock assembly mount 220 away from top hat mount 230 to remove the compression).

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments can be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. A spring compressor comprising:
a frame;
a lower shock assembly mount;
a top hat mount; and
a compressing component coupled with said frame, said lower shock assembly mount, and said top hat mount, said compressing component to provide a compression on a spring by reducing a distance between said lower shock assembly mount and said top hat mount.

2. The spring compressor of claim 1, wherein said frame is a mobile stand.

3. The spring compressor of claim 1, wherein said frame is a wall-mount frame.

4. The spring compressor of claim 1, wherein said compressing component is a pneumatic compressing component.

5. The spring compressor of claim 1, wherein said compressing component is a hydraulic compressing component.

6. The spring compressor of claim 1, wherein said compressing component is a mechanical compressing component.

7. The spring compressor of claim 1, wherein said compressing component is a combination of two or more of a pneumatic compressing component, a hydraulic compressing component, and a mechanical compressing component.

8. The spring compressor of claim 1, wherein said top hat mount is interchangeable for a number of different shock assembly types.

9. The spring compressor of claim 1, further comprising:
a compressing component controller to control an operation of said compressing component.

10. The spring compressor of claim 1, wherein said compressing component moves said top hat mount toward said lower shock assembly mount to provide said compression on said spring, and moves said top hat mount away from said lower shock assembly mount to reduce said compression on said spring.

11. The spring compressor of claim 1, wherein said compressing component moves said lower shock assembly mount toward said top hat mount to provide said compression on said spring, and moves said lower shock assembly mount away from said top hat mount to reduce said compression on said spring.

12. The spring compressor of claim 1, wherein said compressing component moves both said top hat mount and said lower shock assembly mount toward each other to provide said compression on said spring, and moves both said top hat mount and said lower shock assembly mount away from each other to reduce said compression on said spring.

13. A spring compressor comprising:
a frame;
a lower shock assembly mount configured to retain a lower portion of a coil sprung shock assembly;
a top hat mount configured to retain a top hat portion of said coil sprung shock assembly; and
a compressing component coupled with said frame, said lower shock assembly mount, and said top hat mount, said compressing component to provide a compression on a spring of said coil sprung shock assembly by reducing a distance between said lower shock assembly mount and said top hat mount.

14. The spring compressor of claim 13, wherein said frame is selected from a group consisting of: a fixed stand, a mobile stand, and a wall-mount frame.

15. The spring compressor of claim 13, wherein said compressing component is selected from a group consisting of: a pneumatic compressing component, a hydraulic compressing component, a mechanical compressing component, and a combination of two or more of said pneumatic compressing component, said hydraulic compressing component, and said mechanical compressing component.

16. The spring compressor of claim 13, wherein said compressing component moves said top hat mount toward said lower shock assembly mount to provide said compression on said spring of said coil sprung shock assembly, and moves said top hat mount away from said lower shock assembly mount to reduce said compression on said spring of said coil sprung shock assembly.

17. The spring compressor of claim 13, wherein said compressing component moves said lower shock assembly mount toward said top hat mount to provide said compression on said spring of said coil sprung shock assembly, and moves said lower shock assembly mount away from said top hat mount to reduce said compression on said spring of said coil sprung shock assembly.

18. The spring compressor of claim 13, wherein said compressing component moves both said top hat mount and said lower shock assembly mount toward each other to provide said compression on said spring of said coil sprung shock assembly, and moves both said top hat mount and said lower shock assembly mount away from each other to reduce said compression on said spring of said coil sprung shock assembly.

19. A spring compressor comprising:
a lower shock assembly mount configured to retain a lower portion of a coil sprung shock assembly;
a top hat mount configured to retain a top hat portion of said coil sprung shock assembly; and
a compressing component coupled with said lower shock assembly mount and said top hat mount, said compressing component to provide a compression on a spring of said coil sprung shock assembly by reducing a distance between said lower shock assembly mount and said top hat mount.

20. The spring compressor of claim 19 further comprising:
a frame coupled with at least one of said lower shock assembly mount and said compressing component, said frame selected from a group consisting of: a fixed stand, a mobile stand, and a wall-mount frame.
